(19) United States
(12) Patent Application Publication
(10) Pub. No.: US 2025/0384810 A1
(43) Pub. Date: Dec. 18, 2025

(54) SOURCE DRIVER AND DISPLAY APPARATUS COMPRISING THE SAME

(71) Applicant: Anapass Inc., Seoul (KR)

(72) Inventors: Chang Hwan KIM, Seoul (KR); Ji Heon LEE, Seoul (KR)

(21) Appl. No.: 19/222,228

(22) Filed: May 29, 2025

(30) Foreign Application Priority Data
Jun. 7, 2024 (KR) 10-2024-0074477

(51) Int. Cl. G09G 3/20

(52) U.S. Cl. CPC G09G 3/2092; G09G 2310/0275; G09G 2310/08; G09G 2320/0271

(57) ABSTRACT

The present disclosure provides a source driver comprising a plurality of interpolation amplifiers, wherein each interpolation amplifier includes: an input selection unit that receives an upper limit voltage, a lower limit voltage, and pixel data corresponding to a gray level, and outputs logic values according to the gray level; an input stage that receives the logic values and outputs a corresponding current; a load stage that converts the current to an analog voltage and outputs it; and an output stage that outputs the analog voltage, wherein the plurality of interpolation amplifiers are divided into a first group to which first group gray levels are input and a second group to which second group gray levels are input, wherein the interpolation amplifiers included in the first group perform j-bit interpolation on the upper limit voltage and the lower limit voltage to output an interpolated voltage, and the interpolation amplifiers included in the second group perform k-bit interpolation on the upper limit voltage and the lower limit voltage to output an interpolated voltage (j, k: both natural numbers, k>j).

### CROSS-REFERENCE TO RELATED APPLICATIONS

This application claims priority to and the benefit of Korean Patent Application No. 10-2024-0074477, filed on Jun. 7, 2024, the entire contents of which are hereby incorporated by reference.

### BACKGROUND

A display apparatus displays an image on a display panel by providing pixel voltages to panel loads connected to source lines via a source driver, and by providing scan signals via a gate driver. The source driver provides pixel voltages corresponding to digital image data supplied by a timing controller to pixels included in the display panel, thereby forming an image on the display panel.

In conventional display technology, display driver circuits typically control the color and brightness of a screen by adjusting voltage according to gray levels. As display technology advances, resolution continues to increase. Furthermore, to form higher quality images, pixel voltages provided to pixels are becoming increasingly fine-grained. To form and provide these fine-grained voltages to pixels, amplifiers interpolate and output a provided voltage.

### SUMMARY

Gamma voltages for the entire gray level range have a non-linear relationship. However, in conventional technology, interpolation is performed using a fixed number of bits across the entire gray level range, resulting in non-linearity in the output gamma voltages.

Specifically, depending on the range of gray level values, the difference between adjacent gamma voltage values can be significant, necessitating voltage adjustments for compensation. This has created challenges in optimizing power consumption and layout area.

One of the objectives that this disclosure aims to solve is to address these difficulties in conventional technology. Specifically, one objective is to improve display performance by dynamically adjusting the number of bits according to gray levels to perform appropriate interpolation.

According to one aspect of the present disclosure, a source driver comprising a plurality of interpolation amplifiers is provided, wherein each interpolation amplifier includes: an input selection unit that receives an upper limit voltage, a lower limit voltage, and pixel data corresponding to a gray level, and outputs logic values according to the gray level; an input stage that receives the logic values and outputs a corresponding current; a load stage that converts the current to an analog voltage and outputs it; and an output stage that outputs the analog voltage, wherein the plurality of interpolation amplifiers are divided into a first group to which first group gray levels are input and a second group to which second group gray levels are input, wherein the interpolation amplifiers included in the first group perform j-bit interpolation on the upper limit voltage and the lower limit voltage to output an interpolated voltage, and the interpolation amplifiers included in the second group perform k-bit interpolation on the upper limit voltage and the lower limit voltage to output an interpolated voltage (j, k: both natural numbers, k>j).

According to one aspect of the present disclosure, the gamma voltage corresponding to the gray level of the first group is greater than the gamma voltage corresponding to the gray level of the second group.

According to one aspect of the present disclosure, the entire gray level is divided only into the first group and the second group.

According to one aspect of the present disclosure, the number of gray levels belonging to the first group is less than 50% of the total number of gray levels, and the number of gray levels belonging to the second group is 50% or more of the total number of gray levels.

According to one aspect of the present disclosure, the number of gray levels belonging to the first group is less than 25% of the total number of gray levels, and the number of gray levels belonging to the second group is 75% or more of the total number of gray levels.

According to one aspect of the present disclosure, the plurality of interpolation amplifiers are further divided into a third group to which third group gray levels are input, and the interpolation amplifiers included in the third group perform 1-bit interpolation on the upper limit voltage and the lower limit voltage to output an interpolated voltage (j, k, l: all natural numbers, l>k>j).

According to one aspect of the present disclosure, the gamma voltage corresponding to the gray level of the first group is greater than the gamma voltage corresponding to the gray level of the second group, and the gamma voltage corresponding to the gray level of the second group is greater than the gamma voltage corresponding to the gray level of the third group.

According to one aspect of the present disclosure, the entire gray level is divided only into the first group, the second group, and the third group.

According to one aspect of the present disclosure, the number of gray levels belonging to the first group is less than 30% of the total number of gray levels, and the number of gray levels belonging to the third group is 30% or more of the total number of gray levels, and the remaining gray levels belong to the second group.

According to one aspect of the present disclosure, the number of gray levels belonging to the first group is less than 25% of the total number of gray levels, and the number of gray levels belonging to the third group is 50% or more of the total number of gray levels, and the remaining gray levels belong to the second group.

According to the present disclosure, a display apparatus comprising a plurality of interpolation amplifiers is provided, wherein each interpolation amplifier includes: an input selection unit that receives an upper limit voltage, a lower limit voltage, and pixel data corresponding to a gray level, and outputs logic values according to the gray level; an input stage that receives the logic values and outputs a corresponding current; a load stage that converts the current to an analog voltage and outputs it; and an output stage that outputs the analog voltage, wherein the plurality of interpolation amplifiers are divided into a first group to which first group gray levels are input and a second group to which second group gray levels are input, wherein the interpolation amplifiers included in the first group perform j-bit interpolation on the upper limit voltage and the lower limit voltage to output an interpolated voltage, and the interpolation amplifiers included in the second group perform k-bit interpolation on the upper limit voltage and the lower limit voltage to output an interpolated voltage (j, k: both natural numbers, k>j).

### BRIEF DESCRIPTION OF THE DRAWINGS

FIG. 1 is a diagram schematically illustrating a display system.

FIG. 2 is a block diagram exemplifying a source driver that provides pixel data supplied from a timing controller to a display panel.

FIGS. 3 and 4 are diagrams schematically explaining the operation of an interpolation amplifier according to an embodiment.

FIG. 5 is a block diagram showing an overview of an interpolation amplifier according to an embodiment.

FIGS. 6A and 6B are block diagrams showing an overview of an input stage according to an embodiment.

FIG. 7 is an exemplary circuit diagram of an input stage including two unit modules.

FIG. 8 is a schematic circuit diagram of a load stage and an output stage.

### DETAILED DESCRIPTION

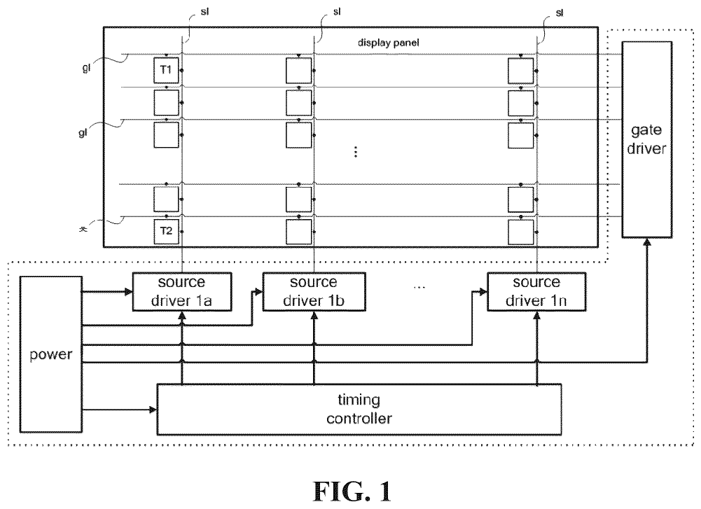

Hereinafter, the source driver and display apparatus according to an embodiment will be described with reference to the accompanying drawings. FIG. 1 is a diagram schematically illustrating a display system. Referring to FIG. 1, the display system according to the present embodiment includes a display panel, a gate driver, source drivers 1a, 1b, . . . , In, and may include a timing controller that adjusts characteristics of screen sources applied from the outside or adjusts driving timing according to the resolution and characteristics of the display system. Depending on the characteristics of the display panel, the timing controller and the source drivers 1a, 1b, . . . , In may be formed as separate chips, or as shown in the illustrated diagram, the timing controller and the source drivers 1a, 1b, . . . , In may be implemented as one chip.

The display panel includes a plurality of pixels T1, T2, each of which is connected to the gate driver through a gate line gl and electrically connected to the source drivers 1a, 1b, . . . , In through a source line sl. The source line delivers the gradation signal that each pixel should display to the pixels.

The source line to the pixel consists of conductive lines, and there exist various parasitic capacitances, including the resistance component of the conductive line, parasitic capacitance between adjacent lines, and parasitic capacitance with a reference electrode. These loads and switches such as thin-film transistors in the pixel can be modeled as resistance-capacitor pairs (RC pairs). That is, the load driven by the source driver has a distributed RC configuration.

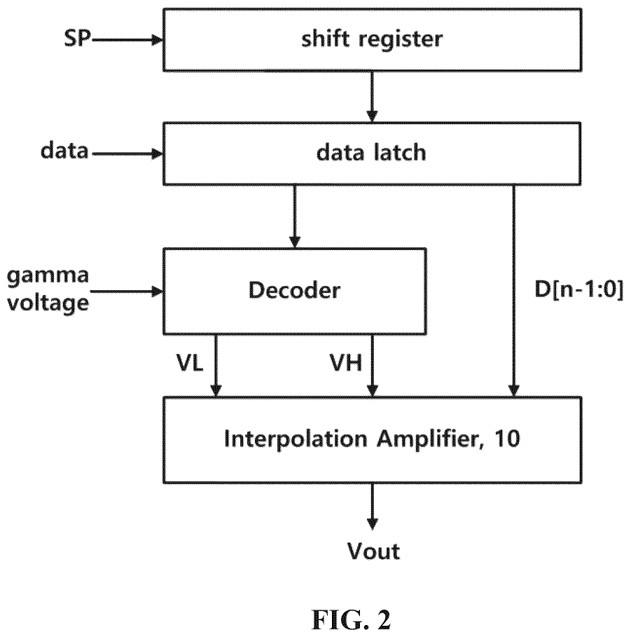

FIG. 2 is a block diagram exemplifying a source driver that provides pixel data supplied from a timing controller (see FIG. 1) to a display panel. Referring to FIG. 2, the signal provided to the display panel passes through a shift register, a data latch, a sample/hold register, a gate driver circuit, a digital-to-analog converter (DAC), and an interpolation amplifier 10 before being provided to the pixel of the display panel.

The shift register sequentially shifts and outputs the input start pulse (SP). The data latch latches up and provides image data. In one embodiment, the data latch may include a sample/hold register that samples and holds the latched-up image signal according to the start pulse (SP).

The decoder, for example, receives a plurality of gamma voltages and pixel data, and selects an upper limit voltage VH and a lower limit voltage VL corresponding to the pixel data from the gamma voltages and outputs them to the interpolation amplifier 10. The interpolation amplifier 10 receives the upper limit voltage VH, the lower limit voltage VL, and pixel data D[n−1:0], and interpolates a voltage between the upper limit voltage VH and the lower limit voltage VL corresponding to the provided pixel data D[n−1:0] and outputs it as Vout.

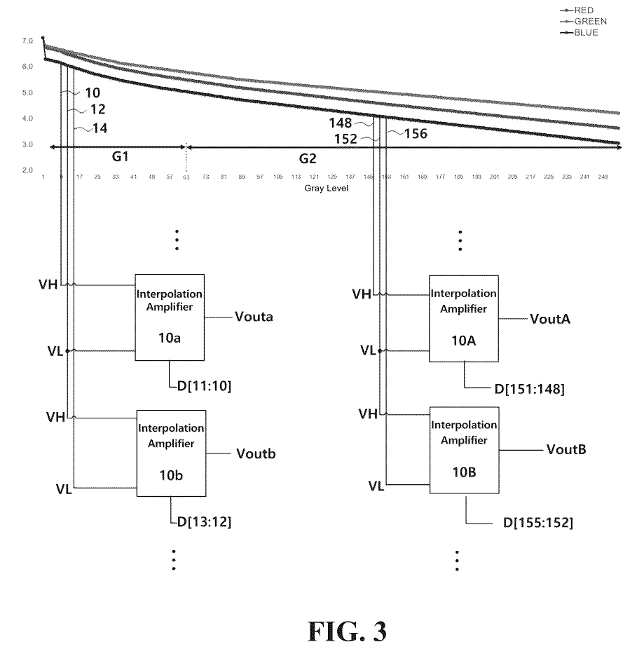

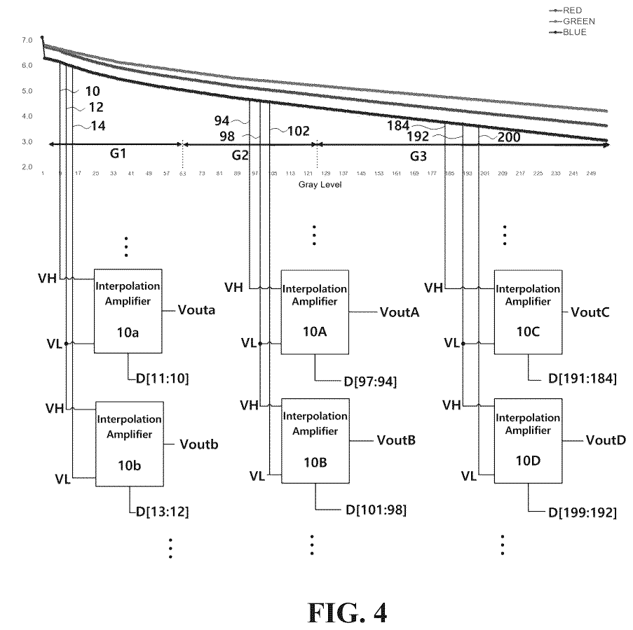

FIGS. 3 and 4 are diagrams schematically explaining the operation of an interpolation amplifier according to an embodiment. FIGS. 3 and 4 show gamma voltage curves representing changes in gamma voltage for R, G, B gray level data and an interpolation amplifier. In FIG. 3, the gray level corresponds to the data represented by D[n−1, 0] in FIG. 2. In FIG. 3, the gray level is exemplified as being divided into a total of 256 levels from 0 to 255, and the corresponding gamma voltage is exemplified as changing from 6.3V to 3.0V for B gamma voltage. However, this is merely exemplary, and the gray level may be divided into a total of 512 levels from 0 to 511. Alternatively, the gray level may be divided into a total of 1024 levels from 0 to 1023.

As shown, R, G, and B gamma voltages change non-linearly according to changes in gray level. The change in gamma voltage is relatively large when the gray level is relatively low, and the change in gamma voltage is relatively small when the gray level is relatively high. Therefore, when the gray level changes between 0 and 1, the change in gamma voltage is greater compared to when the gray level changes between 254 and 255.

The present embodiment divides the entire gray level range into at least two groups, as shown, and performs interpolation differently for each section. The embodiment exemplified by FIG. 3 divides the entire gray level into a first group G1 where the change in gamma voltage is relatively large compared to the change in gray level, and a second group G2 where the change in gamma voltage is relatively small compared to the change in gray level.

For example, the first group G1 may include less than 50% of the gray levels with smaller values among all gray levels, and the second group A2 may include 50% or more of the gray levels with larger values among all gray levels.

In another example, the first group G1 may include less than 30% of the gray levels with smaller values among all gray levels, and the second group G2 may include 70% or more of the gray levels with larger values among all gray levels.

In yet another example, the first group G1 may include less than 25% of the gray levels with smaller values among all gray levels, and the second group G2 may include 75% or more of the gray levels with larger values among all gray levels.

For gray levels belonging to the first group G1, j-bit interpolation is performed to form interpolated voltages, and for gray levels belonging to the second group G2, k-bit interpolation is performed to form interpolated voltages. Both j and k are positive integers, and k is at least 1 greater than j.

In the illustrated example, 1-bit interpolation is performed for the first group G1. Interpolation amplifier 10a receives gamma voltages corresponding to gray levels 10 and 12 as upper limit voltage VH and lower limit voltage VL, respectively. If the input data is D11, it interpolates to correspond to the input data D11 and outputs the interpolated voltage Vouta, and if the input data is D10, it outputs the voltage corresponding to the input data D10 as interpolated voltage Vouta.

Similarly, interpolation amplifier 10b receives gamma voltages corresponding to gray levels 12 and 14 belonging to the first group G1 as upper limit voltage VH and lower limit voltage VL, respectively. If the input data is D13, it interpolates to correspond to the input data D13 and outputs the interpolated voltage Vouta, and if the input data is D12, it outputs the voltage corresponding to the input data D12 as interpolated voltage Voutb.

For the second group G2, 2-bit interpolation is performed. Interpolation amplifier 10A receives gamma voltages corresponding to gray levels 148 and 152 as upper limit voltage VH and lower limit voltage VL, respectively, and interpolates the gamma voltage corresponding to the gray level according to the input data and outputs it as interpolated voltage VoutA. If the input data is D149, D150, D151, the interpolation amplifier 10A interpolates to correspond to the input data D149, D150, D151 and outputs it as interpolated voltage VoutA, and if the input data is D148, it outputs the voltage corresponding to the input data D148 as interpolated voltage VoutA.

Referring to FIG. 4, as shown, the entire gray level range is divided into at least three groups, and interpolation is performed differently for each section. The embodiment exemplified by FIG. 4 divides into a first group G1 where the change in gamma voltage is relatively large compared to the change in gray level, a second group G2 where the change in gamma voltage is relatively small compared to the first group, and a third group G3 where the change in gamma voltage is relatively smaller compared to the second group.

For example, the first group G1 may include 33% of the gray levels from 0 to 84, the second group G2 may include 33% of the gray levels from 85 to 169, and the third group G3 may include the remaining gray levels from 170 to 255.

In another example, the first group G1 may include less than 25% of the gray levels with smaller values among all gray levels, the third group G3 may include 50% or more of the gray levels with larger values among all gray levels, and the second group G2 may include less than 25% of the gray levels with values larger than the first group but smaller than the third group.

For gray levels belonging to the first group G1, j-bit interpolation is performed to form interpolated voltages, for gray levels belonging to the second group G2, k-bit interpolation is performed to form interpolated voltages, and for gray levels belonging to the third group G3, 1-bit interpolation is performed to form interpolated voltages. j, k, and I are all positive integers, k is at least 1 greater than j, and 1 is at least 1 greater than k.

In the illustrated example, 1-bit interpolation is performed for the first group G1. Interpolation amplifier 10a receives gamma voltages corresponding to gray levels 10 and 12 as upper limit voltage VH and lower limit voltage VL, respectively. If the input data is D11, it interpolates to correspond to the input data D11 and outputs the interpolated voltage Vouta, and if the input data is D10, it outputs the voltage corresponding to the input data D10 as interpolated voltage Vouta.

For the second group G2, 2-bit interpolation is performed. Interpolation amplifier 10A receives gamma voltages corresponding to gray levels 94 and 98 as upper limit voltage VH and lower limit voltage VL, respectively, and interpolates the gamma voltage corresponding to the gray level according to the input data and outputs it as interpolated voltage VoutA. Similarly, interpolation amplifier 10B receives gamma voltages corresponding to gray levels 98 and 102 belonging to the second group G2 as upper limit voltage VH and lower limit voltage VL, respectively, and interpolates according to the input data and outputs interpolated voltage VoutB.

For the third group G3, 3-bit interpolation is performed. Interpolation amplifier 10C receives gamma voltages corresponding to gray levels 184 and 192 as upper limit voltage VH and lower limit voltage VL, respectively, and interpolates the gamma voltage corresponding to the gray level according to the input data and outputs it as interpolated voltage VoutC. Similarly, interpolation amplifier 10D receives gamma voltages corresponding to gray levels 192 and 200 belonging to the third group G3 as upper limit voltage VH and lower limit voltage VL, respectively, and interpolates according to the input data and outputs interpolated voltage VoutD.

According to conventional technology, voltages need to change at relatively large intervals at low gray levels, while at high gray levels, voltages need to be adjusted at smaller intervals. This has led to problems of increased layout area and inefficient power consumption even in areas requiring precise interpolation.

This invention aims to solve these challenges and provides the advantage of achieving both power efficiency and layout optimization by adjusting the number of bits according to gray levels to perform optimal interpolation at each gray level.

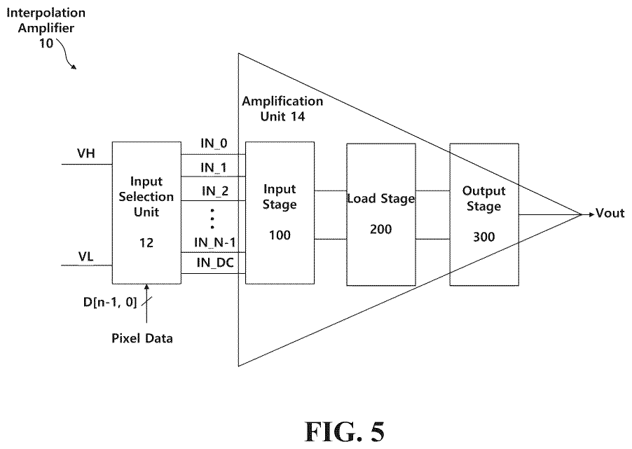

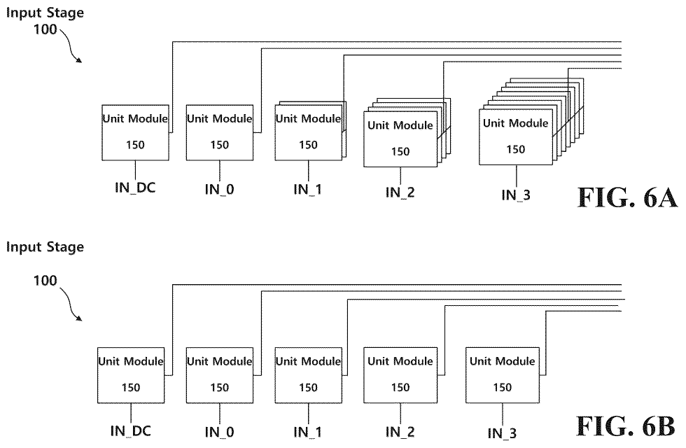

FIG. 5 is a block diagram showing an overview of an interpolation amplifier 10 according to an embodiment. FIG. 6 is a block diagram schematically showing an input stage. Referring to FIGS. 5 and 6, the interpolation amplifier 10 includes an input selection unit 12 and an amplification unit 14. The amplification unit 14 may include an input stage 100, a load stage 200, and an output stage 300.

The input selection unit 12 of the interpolation amplifier 10 exemplified by FIG. 5 receives n bits. For ease of understanding and explanation, the following description is based on the input selection unit 12 receiving 4-bit pixel data D[3,0]. The input selection unit 12 receives 4-bit pixel data D[3,0] and forms and outputs n input voltages (IN_0, IN_1, . . . , IN_3) corresponding to the pixel data. In one embodiment, the input selection unit 12 may further form one IN_DC voltage and output it to the input stage 100 along with the n input voltages. Table 1 below shows a table of 5 output input voltages provided when receiving 4-bit pixel data D[3,0].

As exemplified by FIG. 5 and Table 1 below, the input selection unit 12 may be a logic circuit that receives a high voltage VH and a low voltage VL, and outputs 4-bit input signals (IN_3, IN_2, IN_1, IN_0) and IN_DC according to pixel data D[n−1, 0]. In the example exemplified by Table 1, if the k-th bit of the pixel data D[n−1, 0] is logic high, the input selection unit 12 outputs a low voltage VL at the k-th bit IN_K−1 of the input signal, and if the k-th bit of the pixel data is logic low, it outputs a high voltage VH at the k-th bit of the input. Also, the IN_DC signal may be VH.

In the exemplified embodiment, if the pixel data D[3:0] is 0001, the signals (IN_3, IN_2, IN_1, IN_0) output by the input selection unit 12 may be (VH, VH, VH, VL), and the IN_DC signal may be VH. As shown, IN_DC may output a high voltage VH regardless of the pixel data D[n−1,0] (don't care). The IN_DC signal is a bias signal that supplies the current necessary for the load stage 200 and output stage 300 to operate, and always outputs the VH voltage.

TABLE 1

| D[3:0] | IN3 | IN2 | IN1 | IN0 | IN_DC |
|---|---|---|---|---|---|
| 0000 | VH | VH | VH | VH | VH |
| 0001 | VH | VH | VH | VL | VH |
| 0010 | VH | VH | VL | VH | VH |
| 0011 | VH | VH | VL | VL | VH |
| 0100 | VH | VL | VH | VH | VH |
| 0101 | VH | VL | VH | VL | VH |
| 0110 | VH | VL | VL | VH | VH |
| 0111 | VH | VL | VL | VL | VH |
| 1000 | VL | VH | VH | VH | VH |
| 1001 | VL | VH | VH | VL | VH |
| 1010 | VL | VH | VL | VH | VH |
| 1011 | VL | VH | VL | VL | VH |
| 1100 | VL | VL | VH | VH | VH |
| 1101 | VL | VL | VH | VL | VH |
| 1110 | VL | VL | VL | VH | VH |
| 1111 | VL | VL | VL | VL | VH |

FIG. 6 is a block diagram showing an overview of an input stage 100 according to an embodiment. The input stage forms and outputs a current corresponding to the input signals (IN_3, IN_2, IN_1, IN_0) to the load stage 200 (see FIG. 5). The input stage 100 converts the provided input voltage signals (IN_3, IN_2, IN_1, IN_0) into corresponding currents and outputs them. The input stage 100 may include a plurality of unit modules 150 that output currents corresponding to the provided input signals.

FIG. 6A illustrates an example where the input stage 100 is implemented with unit modules 150 that receive signals and output corresponding currents. As will be described later, the unit module 150 may be implemented as a connected source module 110 (see FIG. 6). In another example, the unit module 150 may be implemented as a separate source module 120 (see FIG. 6). In yet another example, the unit module 150 may be implemented to include both a connected source module 110 (see FIG. 6) and a separate source module 120 (see FIG. 6).

In the illustrated embodiment, IN_0 corresponds to D[0] of D[3:0], IN_1 corresponds to D[1], IN_2 corresponds to D[2], and IN_3 corresponds to D[3]. The input provided to each position has a value twice as large as the previous position. For example, if the value of IN_j is 1 and the value of IN_j+1 is 1, the value of IN_j+1 is twice as large as the value of the previous position IN_j. Therefore, the magnitude of the current output when the j-th input IN_j is provided is twice as large as the magnitude of the current output when the (j−1)th input IN_j−1 is provided.

Referring to FIG. 6A, if unit modules 150 are formed with transistors having the same channel area, the number of unit modules 150 to which input IN_j+1 is provided may be twice the number of unit modules 150 to which input IN_j is provided. Also, the number of unit modules 150 to which input IN_j is provided may be 2\hat{ }j.

In one embodiment, IN_DC is a high voltage VH regardless of the pixel data D[n−1,0] (don't care), and the number of unit modules to which IN_DC is provided as input may be one.

In the embodiment exemplified by FIG. 6B, the number of unit modules 150 to which each bit of the input signal is input may be the same, and the channel area of the transistors included in the unit modules 150 to which each bit of the input signal is input may differ by a factor of two. By forming it this way, the magnitude of the current corresponding to adjacent bits of the input signal may differ by a factor of 2.

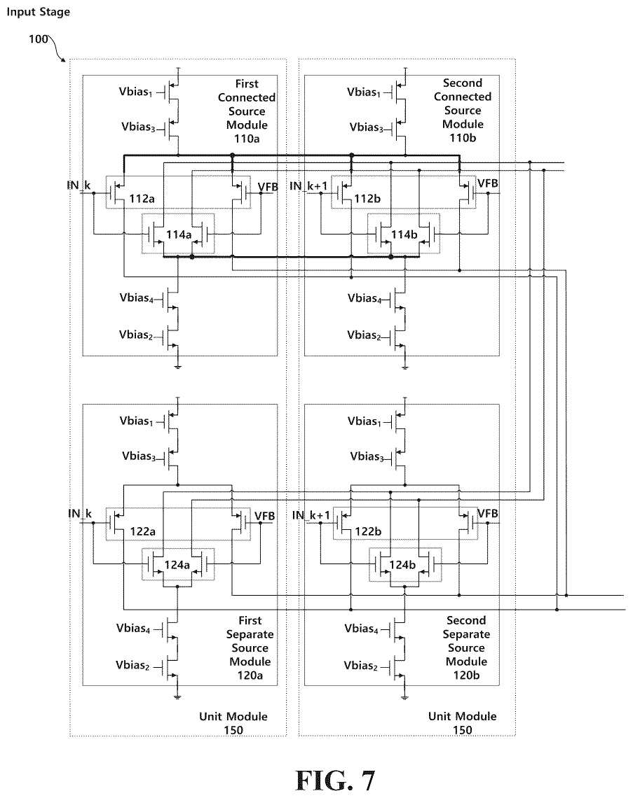

FIG. 7 is an exemplary circuit diagram of an input stage 100 including two unit modules. FIG. 7 exemplifies an embodiment where the input stage 100 is implemented with unit modules including a connected source module 110 and a separate source module 120. Referring to FIG. 7, the connected source module 110 includes two or more connected source modules 110a, 110b, each including a first differential pair 112 and a second differential pair 114 to which input voltage IN_k and the output voltage VFB of the interpolation amplifier are fed back and input, a first current source connected to the first differential pair 112 to provide a bias current, and a second current source connected to the second differential pair to provide a bias current. The sources of the first differential pairs 112a, 112b included in the two or more connected source modules 110a, 110b are connected to each other as shown by the thick lines, and the sources of the second differential pairs 114a, 114b included in the two or more connected source modules 110a, 110b are connected to each other as shown by the thick lines.

In an example not shown, even when the input stage includes three or more connected source modules, the sources of each of the transistors included in the first differential pairs are connected to each other, and the sources of each of the transistors included in the second differential pairs are connected to each other.

In one embodiment, the outputs of the transistors to which input signals IN_k, IN_k+1 are provided in the first differential pair 112a of the first connected source module 110a and the first differential pair 112b of the second connected source module 110b are connected to each other, and the outputs of the transistors to which the fed-back output voltage Vfb is provided are connected to each other.

Also, in the second differential pair 114a and the second differential pair 114b, the outputs of the transistors to which input signals IN_k, IN_k+1 are provided are connected to each other, and the outputs of the transistors to which the fed-back output voltage Vfb is provided are connected to each other.

In an example not shown, when the input stage includes n connected source modules, the outputs of the transistors to which input signals IN_k, IN_k+1 are provided in each of the first differential pairs are connected to each other, and the outputs of the transistors to which the fed-back output voltage Vfb is provided are connected to each other. Also, in each of the second differential pairs, the outputs of the transistors to which input signals IN_k, IN_k+1 are provided are connected to each other, and the outputs of the transistors to which the fed-back output voltage Vfb is provided are connected to each other.

In one embodiment, the input stage 100 may include a plurality of separate source modules 120a, 120b. The separate source module 120a, 120b includes a third differential pair 122 that receives the input voltage IN_k and the output voltage VFB of the interpolation amplifier as feedback and has sources connected to each other, a fourth differential pair 124 that receives the input voltage IN_k and the output voltage Vfb of the interpolation amplifier as feedback and has sources connected to each other, a third current source connected to the third differential pair 122 to provide a bias current, and a fourth current source connected to the fourth differential pair 124 to provide a bias current. Among two or more separate source modules 120a, 120b, the sources of the third differential pair 122a included in one separate source module 120a and the sources of the third differential pair 122b included in another separate source module 120b are not electrically connected to each other, and the sources of the fourth differential pair 124a included in one separate source module 120a and the sources of the fourth differential pair 124b included in another separate source module 120b are not connected to each other.

In one embodiment, the outputs of the transistors to which input signals IN_k, IN_k+1 are provided in the third differential pair 122a of the first separate source module 120a and the third differential pair 122b of the second separate source module 120b are connected to each other, and the outputs of the transistors to which the fed-back output voltage Vfb is provided are connected to each other.

Also, in the fourth differential pair 124a and the fourth differential pair 124b, the outputs of the transistors to which input signals IN_k, IN_k+1 are provided are connected to each other, and the outputs of the transistors to which the fed-back output voltage Vfb is provided are connected to each other.

In one embodiment, the outputs of the transistors to which input signals IN_k, IN_k+1 are provided in the first differential pair 112a, the first differential pair 112b, the third differential pair 122a, and the third differential pair 122b are connected to each other and input to the load stage 200, and the outputs of the transistors to which the fed-back output signal Vfb is provided are connected to each other and input to the load stage 200.

Also, the outputs of the transistors to which input signals IN_k, IN_k+1 are provided in the second differential pair 114a, the second differential pair 114b, the fourth differential pair 124a, and the fourth differential pair 124b are connected to each other and input to the load stage 200, and the outputs of the transistors to which the fed-back output signal Vfb is provided are connected to each other and input to the load stage 200.

In the illustrated embodiment, the first differential pair 112 and the third differential pair 122 are each connected to the first current source and the third current source to provide bias current, and the second differential pair 114 and the fourth differential pair 124 are each connected to the third current source and the fourth current source to provide bias current.

In the illustrated embodiment, the first current source and the third current source are shown as transistors connected in series with bias voltage Vbias1 provided to the gate electrode. However, this is merely an embodiment, and they may be a single transistor with a bias voltage provided or a branch of a current mirror.

In the illustrated embodiment, the second current source and the fourth current source are shown as transistors connected in series with bias voltage Vbias2 provided to the gate electrode. However, this is merely an embodiment, and they may be a single transistor with a bias voltage provided or a branch of a current mirror.

The embodiment exemplified by FIG. 7 shows one each of the first connected source module 110a, the first separate source module 120a to which input IN_K is provided, and the second connected source module 110b and the second separate source module 120b to which input IN_K+1 is provided, for convenience of illustration and explanation. This embodiment is a case where, as exemplified by FIG. 4(b), the channel area of the modules to which input IN_K+1 is provided is at least twice as large as the channel area of the modules to which input IN_K is provided. However, according to an embodiment not shown, the number of second connected source modules 110b may be twice the number of first connected source modules 110a, and the number of second separate source modules 120b may be twice the number of first separate source modules 120a.

In the embodiment exemplified by FIG. 7, if the input IN_k applied to the first differential pair 112a, the second differential pair 114a, the third differential pair 122a, and the fourth differential pair 124a is a low voltage VL, the NMOS transistors of the second differential pair 114a and the fourth differential pair 124a to which the input IN_k is applied are cut off, but the PMOS transistors of the first differential pair 112a and the third differential pair 122a to which the input IN_k is applied conduct. Therefore, the current provided from the current source is provided to the load stage 200 (see FIG. 3) through the drain electrode, which is the output node, to form a corresponding voltage.

Also, if the input IN_k+1 applied to the first differential pair 112b, the second differential pair 114b, the third differential pair 122b, and the fourth differential pair 124b is a low voltage VL, the NMOS transistors of the second differential pair 114b and the fourth differential pair 124b to which the input IN_k+1 is applied are cut off, but the PMOS transistors of the first differential pair 112b and the third differential pair 122b to which the input is applied conduct. The current provided from the current source is provided to the load stage through the drain electrode, which is the output node. The case where the input IN_k+1 is a low voltage VL has been explained, but in the case where the input IN_k+1 is a high voltage VH, the second and fourth differential pairs to which the input is provided conduct and provide current to the load stage to generate a corresponding voltage.

The voltage formed in the load stage 200 (see FIG. 3) corresponds to the superposition of the voltage formed by the current output by the first connected source module 110a and the first separate source module 120a, and the voltage formed by the current output by the second connected source module 110b and the second separate source module 120b.

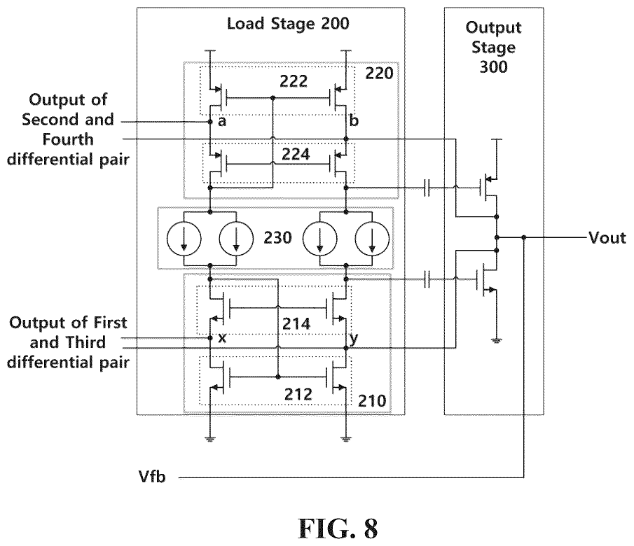

FIG. 8 is a schematic circuit diagram of a load stage 200 and an output stage 300. Referring to FIG. 8, the load stage 200 includes an NMOS transistor folded cascode circuit 210, a PMOS transistor folded cascode circuit 220, and a current source 230 connected in parallel between the PMOS transistor folded cascode circuit 220 and the NMOS transistor folded cascode circuit 210.

The NMOS folded cascode circuit 210 includes a first paired gate circuit 212 comprising transistors with connected gates and a second paired gate circuit 214 comprising transistors with connected gates, with the first paired gate circuit 212 and the second paired gate circuit 214 connected in cascode. The node where the gates are connected in the first paired gate circuit 212 is connected to the drain electrode of the transistor in the second paired gate circuit 214.

The PMOS folded cascode circuit 220 includes a third paired gate circuit 222 comprising transistors with connected gates and a fourth paired gate circuit 224 comprising transistors with connected gates, with the third paired gate circuit 222 and the fourth paired gate circuit 224 connected in cascode. The node where the gates are connected in the third paired gate circuit 222 is connected to the drain electrode of the transistor in the fourth paired gate circuit 224.

The output current of the transistors to which input signals IN_k, IN_k+1 are provided in the first differential pair 112a, the first differential pair 112b, the third differential pair 122a, and the third differential pair 122b is input to node x of the load stage 200, and the output current of the transistors to which the fed-back output signal Vfb is provided is input to node y of the load stage 200 and converted into a corresponding voltage.

Also, the outputs of the transistors to which input signals IN_k, IN_k+1 are provided in the second differential pair 114a, the second differential pair 114b, the fourth differential pair 124a, and the fourth differential pair 124b are connected to each other and input to node a of the load stage 200, and the outputs of the transistors to which the fed-back output signal Vfb is provided are connected to each other and input to node b of the load stage 200 and converted into a corresponding voltage.

The voltage converted and output by the load stage 200 is provided to the output stage 300 through a coupling capacitor. In the illustrated embodiment, the output stage 300 includes a push-pull amplifier comprising a PMOS transistor and an NMOS transistor. However, in another embodiment not shown, the output stage may be implemented with a different power amplifier circuit. Thus, the current output by the input stage 100 is converted into voltage by the load stage, and the output voltage amplified by the output stage is fed back and provided to the input stage 100.

The present invention has been described with reference to the illustrated embodiments for better understanding, but these are for illustrative purposes only and are not limiting. Those skilled in the art will understand that various modifications and equivalent other embodiments are possible from this. Therefore, the true technical scope of the present invention should be determined by the appended claims.

What is claimed is:

1. A source driver comprising a plurality of interpolation amplifiers, wherein each interpolation amplifier comprises:
an input selection unit that receives an upper limit voltage, a lower limit voltage, and pixel data corresponding to a gray level, and outputs logic values according to the gray level;
an input stage that receives the logic values and outputs a corresponding current;
a load stage that converts and outputs the current to an analog voltage; and
an output stage that outputs the analog voltage,
wherein the plurality of interpolation amplifiers are divided into a first group to which first group gray levels are input and a second group to which second group gray levels are input,
wherein the interpolation amplifiers included in the first group perform j-bit interpolation on the upper limit voltage and the lower limit voltage to output an interpolated voltage, and
the interpolation amplifiers included in the second group perform k-bit interpolation on the upper limit voltage and the lower limit voltage to output an interpolated voltage (j, k: both natural numbers, k>j).

2. The source driver of claim 1, wherein the gamma voltage corresponding to the gray level of the first group is greater than the gamma voltage corresponding to the gray level of the second group.

3. The source driver of claim 1, wherein the entire gray level is divided only into the first group and the second group.

4. The source driver of claim 3, wherein the number of gray levels belonging to the first group is less than 50% of the total number of gray levels, and the number of gray levels belonging to the second group is 50% or more of the total number of gray levels.

5. The source driver of claim 3, wherein the number of gray levels belonging to the first group is less than 25% of the total number of gray levels, and the number of gray levels belonging to the second group is 75% or more of the total number of gray levels.

6. The source driver of claim 1, wherein the plurality of interpolation amplifiers are further divided into a third group to which third group gray levels are input, and the interpolation amplifiers included in the third group perform 1-bit interpolation on the upper limit voltage and the lower limit voltage to output an interpolated voltage (j, k, l: all natural numbers, l>k>j).

7. The source driver of claim 6, wherein the gamma voltage corresponding to the gray level of the first group is greater than the gamma voltage corresponding to the gray level of the second group, and the gamma voltage corresponding to the gray level of the second group is greater than the gamma voltage corresponding to the gray level of the third group.

8. The source driver of claim 6, wherein the entire gray level is divided only into the first group, the second group, and the third group.

9. The source driver of claim 8, wherein the number of gray levels belonging to the first group is less than 30% of the total number of gray levels, the number of gray levels belonging to the third group is 30% or more of the total number of gray levels, and the remaining gray levels belong to the second group.

10. The source driver of claim 3, wherein the number of gray levels belonging to the first group is less than 25% of the total number of gray levels, the number of gray levels belonging to the third group is 50% or more of the total number of gray levels, and the remaining gray levels belong to the second group.

11. A display apparatus comprising a plurality of interpolation amplifiers, wherein each interpolation amplifier comprises: an input selection unit that receives an upper limit voltage, a lower limit voltage, and pixel data corresponding to a gray level, and outputs logic values according to the gray level; an input stage that receives the logic values and outputs a corresponding current; a load stage that converts the current to an analog voltage and outputs it; and an output stage that outputs the analog voltage, wherein the plurality of interpolation amplifiers are divided into a first group to which first group gray levels are input and a second group to which second group gray levels are input, wherein the interpolation amplifiers included in the first group perform j-bit interpolation on the upper limit voltage and the lower limit voltage to output an interpolated voltage, and the interpolation amplifiers included in the second group perform k-bit interpolation on the upper limit voltage and the lower limit voltage to output an interpolated voltage (j, k: both natural numbers, k>j).

12. The display apparatus of claim 11, wherein the gamma voltage corresponding to the gray level of the first group is greater than the gamma voltage corresponding to the gray level of the second group.

13. The display apparatus of claim 11, wherein the entire gray level is divided only into the first group and the second group.

14. The display apparatus of claim 13, wherein the number of gray levels belonging to the first group is less than 50% of the total number of gray levels, and the number of gray levels belonging to the second group is 50% or more of the total number of gray levels.

15. The display apparatus of claim 13, wherein the number of gray levels belonging to the first group is less than 25% of the total number of gray levels, and the number of gray levels belonging to the second group is 75% or more of the total number of gray levels.

16. The display apparatus of claim 11, wherein the plurality of interpolation amplifiers are further divided into a third group to which third group gray levels are input, and the interpolation amplifiers included in the third group perform 1-bit interpolation on the upper limit voltage and the lower limit voltage to output an interpolated voltage (j, k, l: all natural numbers, l>k>j).

17. The display apparatus of claim 16, wherein the gamma voltage corresponding to the gray level of the first group is greater than the gamma voltage corresponding to the gray level of the second group, and the gamma voltage corresponding to the gray level of the second group is greater than the gamma voltage corresponding to the gray level of the third group.

18. The display apparatus of claim 16, wherein the entire gray level is divided only into the first group, the second group, and the third group.

19. The display apparatus of claim 13, wherein the number of gray levels belonging to the first group is less than 30% of the total number of gray levels, the number of gray levels belonging to the third group is 30% or more of the total number of gray levels, and the remaining gray levels belong to the second group.

20. The display apparatus of claim 13, wherein the number of gray levels belonging to the first group is less than 25% of the total number of gray levels, the number of gray levels belonging to the third group is 50% or more of the total number of gray levels, and the remaining gray levels belong to the second group.
